(19) United States
(12) Patent Application Publication
(10) Pub. No.: US 2012/0267404 A1
(43) Pub. Date: Oct. 25, 2012

(54) Modular Vehicle-Mounted Storage System

(76) Inventors: Paul Rottinghaus, Charles City, IA (US); John Kuhn, New Hampton, IA (US)

(21) Appl. No.: 13/450,777

(22) Filed: Apr. 19, 2012

Related U.S. Application Data
(60) Provisional application No. 61/476,853, filed on Apr. 19, 2011.

(51) Int. Cl. B60R 9/06; B21D 53/88

(52) U.S. Cl. 224/404; 224/547; 224/552; 29/897.2

(57) ABSTRACT

A modular vehicular storage system includes a sub-frame coupleable to a vehicle chassis. The sub-frame is selectively configurable between an expanded and retracted position to accommodate a variety of vehicle widths. At least one storage element, such as a storage container, is mountable to the sub-frame for securing a number of items. The storage container may include a base and a cover movably coupled to the base between an open and closed position for selective access to the interior of the storage container. The sub-frame may accommodate any number of alternative storage elements and may be configured to simultaneously support a number of different storage elements at a given time to provide the user with a number of storage options.

### CROSS-REFERENCE TO RELATED APPLICATIONS

This application claims priority to U.S. Provisional Patent Application No. 61/476,853 filed on Apr. 19, 2011 and entitled Modular Vehicle-Mounted Storage System, the entirety of which is hereby incorporated by explicit reference thereto.

### BACKGROUND OF THE INVENTION

This invention relates to a modular vehicle-mounted storage system, and more particularly to a modular vehicle-mounted storage system including a selectively configurable sub-frame that may be secured to a vehicle and which may include one or more storage containers, boxes, racks, or other storage elements for securely holding any number of items for transport by the vehicle.

Vehicular storage systems are generally known in the art. The known storage systems are generally configured to fit a single chassis size and type. Accordingly, to accommodate a wide variety of chassis sizes and types, the storage systems must be especially constructed to accommodate the various chassis constructions, which is understandably not cost effective.

These known systems typically include a number of storage boxes or containers mounted to the rear of the vehicle. The storage boxes are typically relatively large and include a cover for securing items within the storage boxes. Known storage boxes require that the operator enter the rear of the vehicle to open the storage boxes or require the operator to step into traffic when, e.g., parked at the side of the road, in order to open the storage box, such as when the storage box includes a side-hinged door. Moreover, some known storage boxes require that the operator climb into the rear of the vehicle to access the contents of the box, or require the operator to lift the items out of the storage containers over the sides of the boxes, which may be particularly difficult when lifting large, heavy, and/or unwieldy items.

Accordingly, a vehicular storage system that overcomes one or more of the foregoing disadvantages is desired.

### SUMMARY OF THE INVENTION

The present disclosure is generally directed to a modular vehicle-mounted storage system. The storage system includes a configurable sub-frame that is movable along its width to fit a number of different vehicle chassis sizes and types. The sub-frame is configured to support one or more storage containers or boxes for storing a number of items. The storage containers may include a base and a cover movably mounted to the base for movement between an open and a closed position to secure the items within an interior of the storage container. The interior of the storage container may be selectively configured into a number of compartments. The sub-frame may support any number of alternative storage elements or may support a flat storage platform configured to receive a number of items thereon.

Various other features, objects and advantages of the present invention will be made apparent from the following detailed description and the drawings.

### BRIEF DESCRIPTION OF THE DRAWINGS

The drawings illustrate one representative embodiment presently contemplated for carrying out the invention.

In the drawings:

FIG. 1 is an isometric view of a vehicle including a modular storage system according to the invention;

FIG. 2 is an exploded view of the modular storage system of FIG. 1;

FIG. 3 is a partial cross-section of the modular storage system of FIG. 1 with reference to line 3-3 of FIG. 2, showing the modular storage system in a first, expanded position;

FIG. 4 is a partial cross-section of the modular storage system of FIG. 1 similar to FIG. 3, showing the modular storage system in a second, contracted position;

FIG. 5 is an isometric view of a storage container of the modular storage system of FIG. 1 showing a cover of the storage container in a closed position;

FIG. 6 is an isometric view of the storage container of FIG. 5 showing the cover of the storage container in an open position;

FIG. 7 is a top cross-sectional view of the storage container of FIG. 5 taken along line 7-7 of FIG. 6;

FIG. 8 is an end cross-sectional view of the storage container of FIG. 5 taken along line 8-8 of FIG. 6;

FIG. 9 is a partial enlarged view of a rear end of a divider of the storage container of FIG. 5;

FIG. 10 is a partial enlarged view of a forward end of the divider of the storage container of FIG. 5;

FIG. 11 is a partial view of the storage container of FIG. 5 showing a latch assembly thereof;

FIG. 12 is a partially exploded isometric view of a storage container according to another construction thereof;

FIG. 13 is an isometric view of a storage accessory adapted for use in the storage container of FIG. 5, in the form of a storage tray;

FIG. 14 is an isometric view of another storage accessory adapted for use in the storage container of FIG. 5, in the form of a storage bin;

FIG. 15 is an isometric view of another storage accessory adapted for use in the storage container of FIG. 5, in the form of a can holder;

FIG. 16 is an isometric view of another storage accessory adapted for use in the storage container of FIG. 5, in the form of atowing accessory holder;

FIG. 17 is an isometric view of another storage accessory adapted for use in the storage container of FIG. 5, in the form of along-handled tool holder;

FIG. 18 is a partial isometric view of another construction of a modular storage system of the invention including an alternative construction of a storage container thereof, showing the doors of the storage system in a closed configuration;

FIG. 19 is a partial isometric view similar to FIG. 18, showing the doors of the storage system in an open configuration;

FIG. 20 is a cross-sectional view of the storage container of FIG. 18 taken along line 20-20 of FIG. 18;

FIG. 21 is an isometric view of a vehicle including another construction of a modular storage system according to the invention;

FIG. 22 is a partial isometric view of a vehicle including another construction of a modular storage system according to the invention;

FIG. 23 is a partial side elevation view of the modular storage system of FIG. 22; and

FIG. 24 is an end elevation view of the vehicle including the modular storage system of FIG. 22.

### DETAILED DESCRIPTION

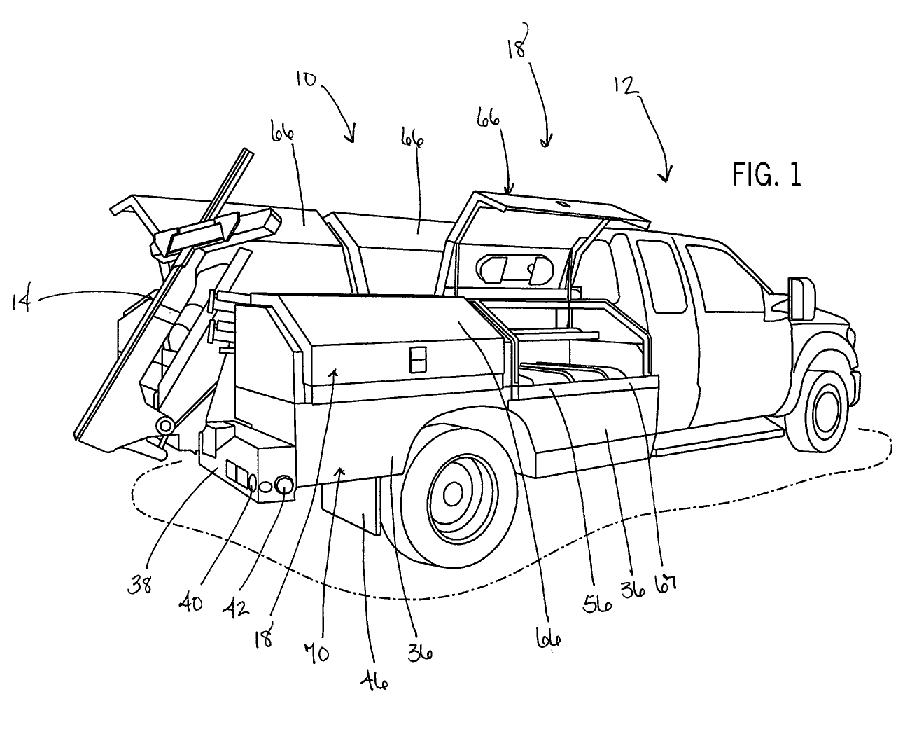

Referring now to the drawings, and initially to FIG. 1, a service body for a work vehicle includes a modular storage system 10 according to the present invention, which is shown mounted to a rear of a vehicle shown at 12. The vehicle 12 may be, for example, a tow truck, UTV or any other similar vehicle where rear storage of a number of items for transport may be desired. As illustrated in FIG. 1, the vehicle 12 may be in the form of a tow truck including a rear mounted towing assembly 14, as is known in the art, configured to be secured to another vehicle (not shown) for towing the other vehicle.

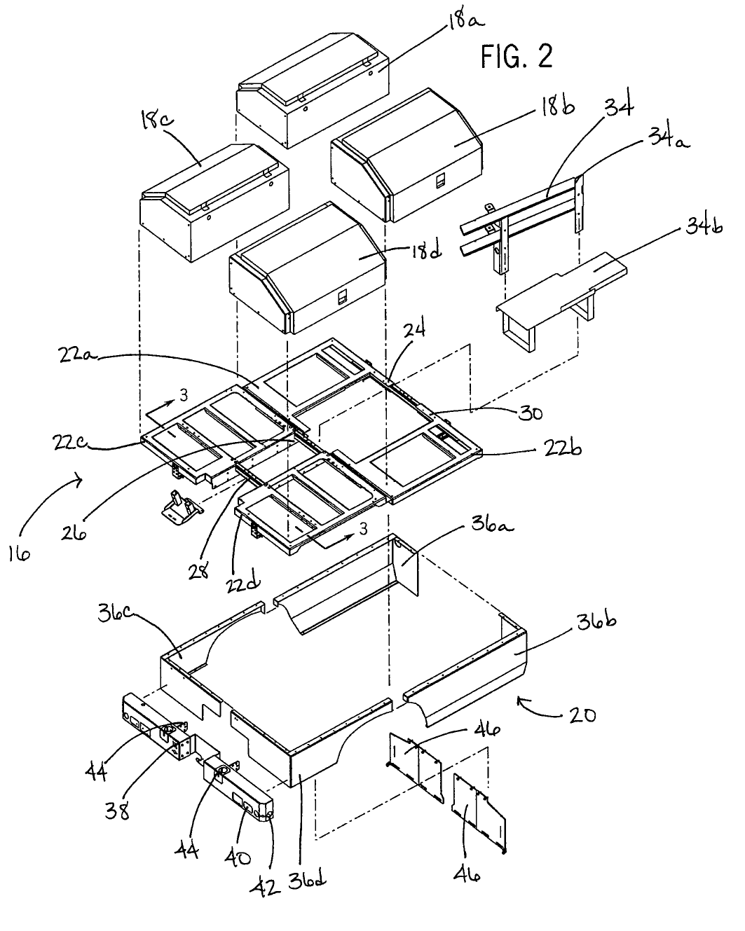

The storage system 10 of the present invention includes a sub-frame 16 (See FIG. 2) that is securely mounted to the rear of the chassis of vehicle 12. The sub-frame 16 may be configured for use with multiple brands of vehicles and chassis as well as different sized vehicles and chassis. Moreover, the sub-frame 16 may be configured for securing to the chassis of the vehicle 12 without the use of, for example, a crane or similar lifting device. In this manner, the securing of the sub-frame 16 to the chassis is greatly simplified as compared to other types of known storage systems. The sub-frame 16 may be configured to support a number of modular storage elements or may support a flat platform or other such element configured to securely support a number of items for transport as may be desired. As illustrated, the sub-frame 16 is configured to support a number of modular storage containers 18. In one construction of the storage system 10, the sub-frame 16 is configured to support four modular storage containers 18 as illustrated in FIG. 1. Understandably, the sub-frame 16 may be configured to support more or less than four storage containers 18. In addition, while the storage containers 18 are shown as being of uniform size and shape, it is readily appreciated that the storage containers 18 may be differently sized and shaped.

With additional reference to FIG. 2, the service body incorporating the storage system 10 is shown in additional detail. In addition to the storage containers 18 and the sub-frame 16, the service body also includes a body portion 20 adapted to be mounted to sub-frame 16.

The sub-frame 16 includes a number of frame members 22 configured to securely support the storage containers 18. The frame members 22 include respective front left and right frame members 22a and 22b and respective rear left and right frame members 22c and 22d, which are correspondingly configured to support respective front left and right storage containers 18a and 18b and respective rear left and right storage containers 18c and 18d. The frame members 22 are movably coupled to one another for selectively increasing and decreasing the width of the sub-frame 16 to accommodate differently sized chassis and vehicle constructions. In particular, the frame members 22 are coupled to one another by rail members 24, 26, and 28, which extend transversely to a length of the vehicle 12 and which are situated forward, medially, and rearward with respect to the front of the vehicle 12, respectively. The frame members 22 include laterally extending rail engaging members 30 configured to enable the frame members 22 to more relative to the rail members 24, 26, and 28. In one construction of the storage system 10, the front frame members 22a and 22b and the rear frame members 22c and 22d are configured to be positioned on the rail members 24, 26, 28 independently of one another so that the width of the front of the sub-frame 16 may differ from the rear. Understandably, the storage system 10 may alternatively be configured such that the frame members 22 move inter-dependently such that the movement of one set of frame members results in the movement of the others, i.e., front and rear.

Still referring to FIGS. 1 and 2, the frame members 22 may include a number of apertures 32 disposed about the sub-frame 16. The apertures 32 may be configured to receive fasteners for coupling, e.g., the storage containers 18 to the sub-frame 16 or the like. For instance, the sub-frame 16 may be configured to support one or more auxiliary components of the storage system 10 such as, e.g., a storage rack 34, which may be interposed between one of the front and rear storage containers 18a, 18b and 18c, 18d. The storage rack 34 may have a two-piece construction like that illustrated or may be integrally constructed. As illustrated, the storage rack 34 includes a generally vertical rack member 34a and a generally horizontal rack member 34b. The storage rack 34 may be configured for securely holding any number of items as may be desired by the user of the storage system 10.

The body portion 20 may include a number separate body panels 36a, 36b, 36c, 36d (collectively, panels 36). The panels 36 of the body 20 may be skirted to provide for an aesthetically pleasing construction. The body panels 36a, 36c and 36b, 36d can longitudinally overlap each other over to varying degrees over the rear tires of the vehicle, to accommodate vehicles of differing length. In addition, the body panels 36a, 36b and 36c, 36d can be selectively positioned closer or farther apart from each other, to accommodate varying widths of the subframe 16. Body portion 20 may further include a rear bumper member 38 adapted to be coupled to the rear of the body portion 20. In the illustrated embodiment, the rear bumper member 38 may be configured to include means for mounting to, for instance, rear cross-panels 36e, 36 that extend toward each other from the rear ends of respective body panels 36c, 36e. Moreover, the rear bumper member 38 may include taillights 40 and reflectors 42 of the kind generally known in the art. The taillights 26 may be electrically operably coupled to the lighting system of the vehicle 12 for operation therewith. The rear bumper 38 may also be secured to the chassis of the vehicle 12 by a number of brackets 44, which may be secured to the chassis by a number of fasteners (not shown). The central portion of the bumper member 38 may include a U-shaped indentation area, which may fit within an opening defined by the facing inner ends of the rear cross-panels 36e, 36f, which may be configured to receive a license plate. A number of flap members 46 may be mounted on the body portion 20 for providing protection to the underbody of the vehicle 12 as may be desired.

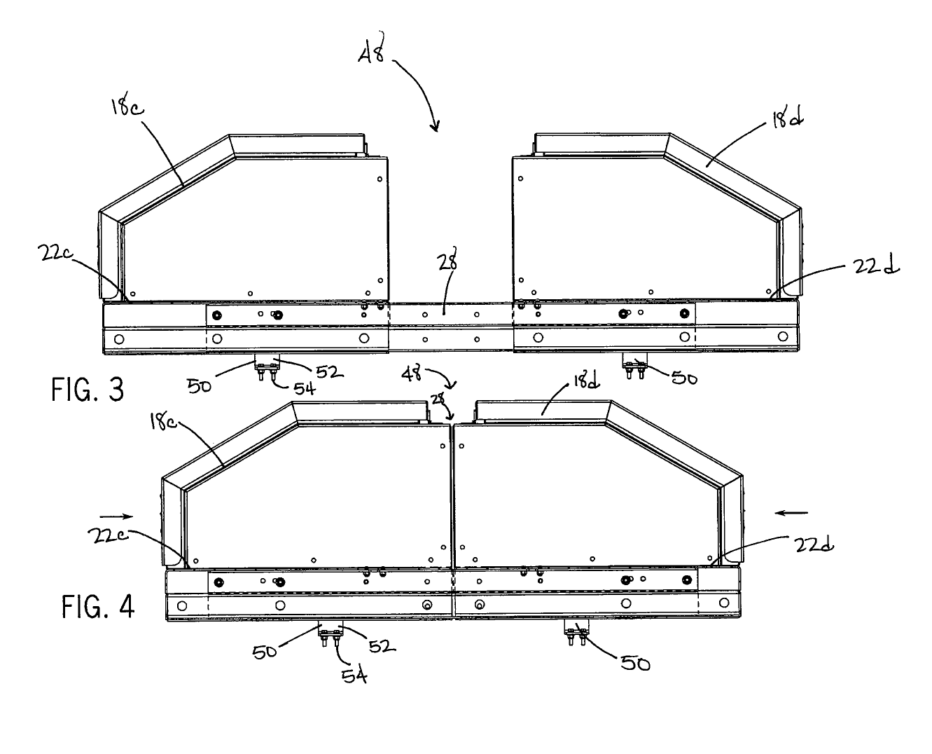

With additional reference now to FIGS. 3 and 4, the sub-frame 16 is shown in its fully extended position (FIG. 3) and its fully contracted position (FIG. 4). As may be appreciated, the sub-frame 16 may be selectively positioned at any number of intermediate positions as may be desired or may be alternatively configured so that it may be positioned at a number of alternative positions. Referring initially to FIG. 3, when the sub-frame 16 is in its extended position the storage containers 18 are positioned at a predetermined lateral distance from one another to define a space 48. The space 48 may be utilized by the operator of the vehicle 12 to store or transport items or may be used as a path to allow for operator travel from the rear of the vehicle 12 toward the front and vice versa as may be appreciated. In this manner, an operator may selectively configure the storage system 10 for any number of purposes as may be desired. The sub-frame 16 may be coupled to the chassis by a series of mounting assemblies 50, which may include a bracket 52 that extends downwardly from the sub-frame 16 and which is coupled to the chassis by a number of fasteners 54, e.g., a bolt, screw, or the like. Understandably, the sub-frame 16 may be coupled to the chassis in any other suitable manner or may be integrally formed therewith. Representatively, the mounting brackets 52 may be mounted to the subframes 22a, 22b, 22c and 22d, and movable to varying positions to accommodate different positions of the chassis members relative to the components of subframe 16.

Referring now to FIG. 4 in particular, the storage system 10 is shown in the contracted position in which the storage containers 18 on opposing lateral sides are shown in abutting or immediately adjacent relationship to one another. To move between the extended and contracted positions, the rail engaging members 30 of the frame members 22 are moved relative to the rails 24, 26, and 28 such that the frame members 22 are moved therealong to position the sub-frame as desired. In this manner, the storage system 10 may be configured in a number of different ways as may be desired to accommodate vehicles and chassis having different sizes and configurations.

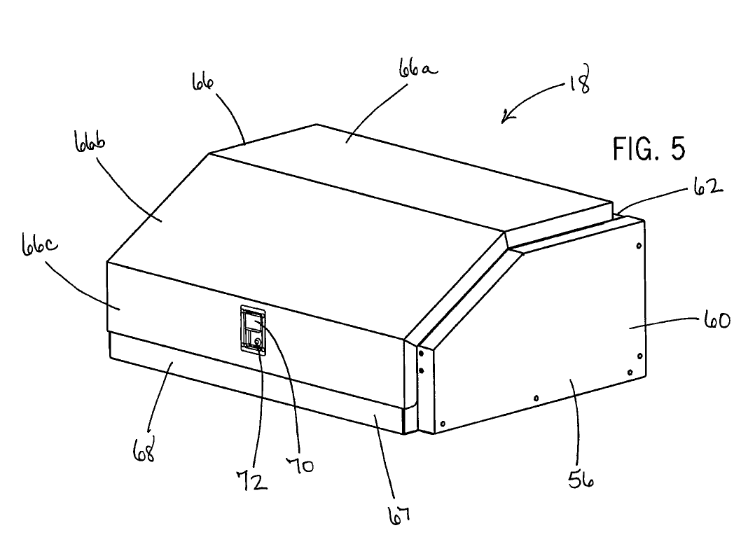

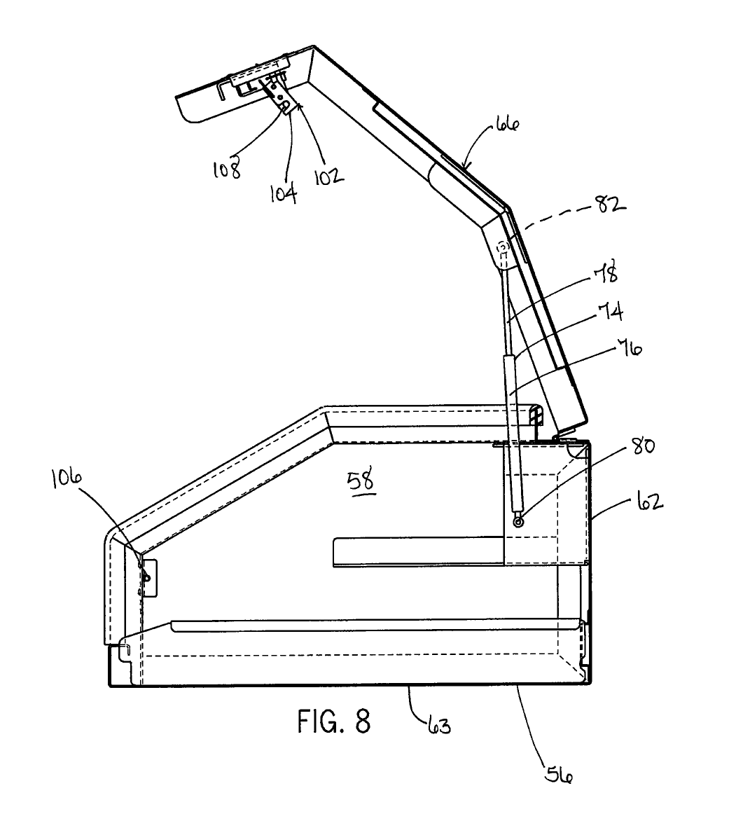

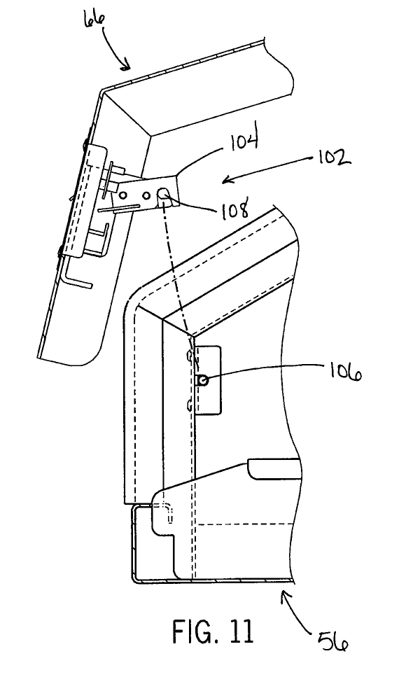

With additional reference now to FIGS. 5-12, the storage container 18 of the storage system 10 is shown in additional detail. The storage container 18 may be constructed from a metal such as aluminum or any other suitable material. The storage container 18 may be constructed from a material that is relatively easily manipualable by a user yet relatively sturdy to be able to withstand wear and tear and weather exposure associated with travel in the rear of a vehicle 12 and to protect the items stored within the storage containers 18.

The storage containers 18 may include a base 56 having a pair of opposed side walls 58 and 60, a rear wall 62, and a bottom wall 63 that cooperate to define an interior 64 for storing items. The side walls 58 and 60 may be generally rectangularly shaped or, as illustrated, may have a generally sloped or angled upper edge configured to correspond with the shape of a cover 66 as will be discussed herein. The cover 66 is movably coupled to the base 56 at an upper edge of the rear wall 62 and may be movable between an open position in which the cover 66 is positioned generally orthogonally with respect to a horizontal axis and a closed position in which a lower edge of the cover 66 matingly engages a front lip 67 of the base 56 of the storage container 18 for selectively covering the interior 64 as desired. The cover 66 is configured to extend from the rear wall 62 and forwardly and downwardly to the front lip 67 of the base 56. In this manner, when the cover 66 is moved to the open position, the interior 64 is more readily accessible in that the user need only lift the items stored therein over the forward edge of the storage container 18. That is, the base 56 and cover 66 are configured such that, when cover 66 is opened, both the top and the upper portion of the front of base 56 are exposed. This provides an ergonomically advantageous design in moving items into or out of the interior of base 56. In addition, the cover 66 is configured to swing open away from the user, which is particularly advantageous in that the user does not have to move into traffic when parked at the side of the road to open the cover 66 and to access the interior 64. The cover 66 may be hingedly coupled to the base 56 or may otherwise be coupled for movement between the open and closed positions. The cover 66 may include one or more separate sections or portions 66a, 66b, and 66c separated by edges formed therebetween. In particular, the sections of the cover 66 may include any number of bends such that the cover 66 provides an aesthetically pleasing and streamlined appearance. Understandably, the cover 66 may have any number of alternative constructions. The sides 58 and 60 of the base 56 may extend laterally beyond a lateral edge of the cover 66 or may be provided flush with the cover 66 to provide further protection from the ingress of rain, snow, debris or the like.

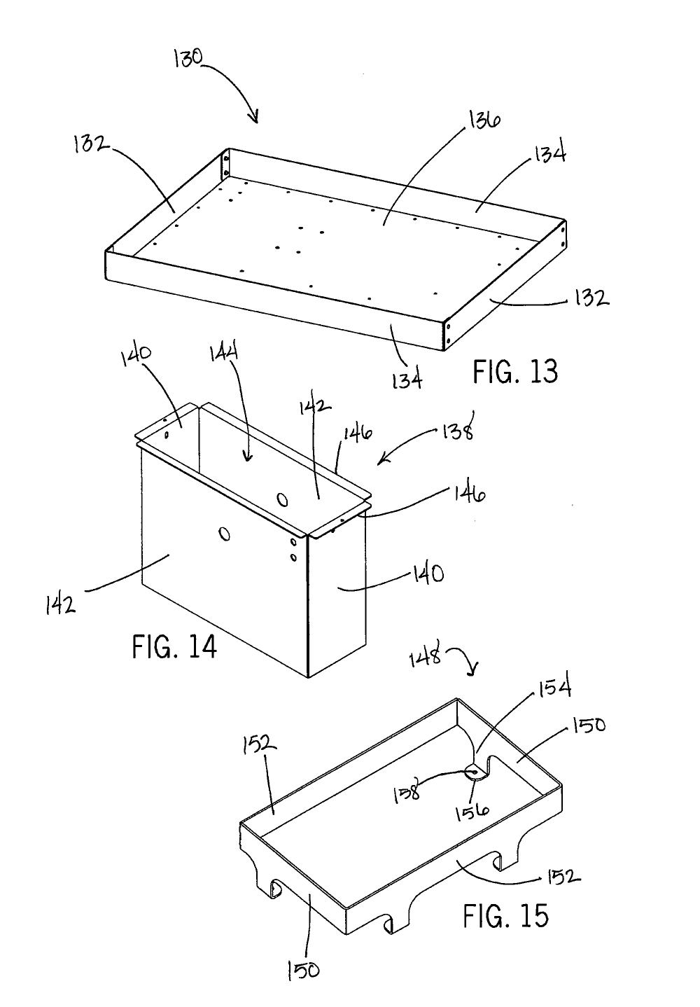

In at least one construction, the storage containers 18 do not include a cover like that illustrated. Of course, the system 10 of the present invention may be configured such that some of the storage containers 18 include covers and some do not. In one construction of the storage system 10, the covers 66 are selectively removable by an operator thereof. In this manner, the operator may selectively configure the storage containers 18 in any manner desired for holding any number of differently sized items. In yet another construction of the storage system 10 of the present invention, one or more of the storage containers 18 may be replaced by a relatively flat pan unit (See FIG. 13) for accommodating any number of items including those that would not fit within the storage containers 18, other components (See FIGS. 14-17) in a mix-and-match manner, which provides flexibility that enables the storage system 10 to used for a variety of purposes, and to be customized as desired.

Each storage container 18 may include a handle assembly 68. The handle assembly 68 may include a handle member 70 graspable by a user. The handle member 70 may be hidden so that it rotates about a horizontal hinge axis in order to release the cover 66 from the base 56. In this manner, the cover 66 may be rotated about its hinges between the open position and the closed position. The handle assembly 68 may further include an undercut portion or recess having a locking element 72. The locking elements 72 may have a receiver for a key or the like. The locking elements 72 may be operably coupled to the handle member 70 such that when the locking element 72 is in the locked position, the handle member 70 is restrained for movement and when the locking elements 72 is unlocked, the handle member 70 is movable for opening the cover 66. In this manner, the user may selectively lock and unlock the cover 66 with respect to the base 56. The handle assembly 68 may be provided on any one of the sections or portions 66a-66c of the cover 66. Understandably, the handle assembly 68 may be provided on the lower portion 66c in order to be positioned at or near arm level of the user. Any number of alternative handle arrangements is within the scope of the present invention. For instance, the locking elements 72 may be a hasp configured for receiving a padlock or combination lock or the like.

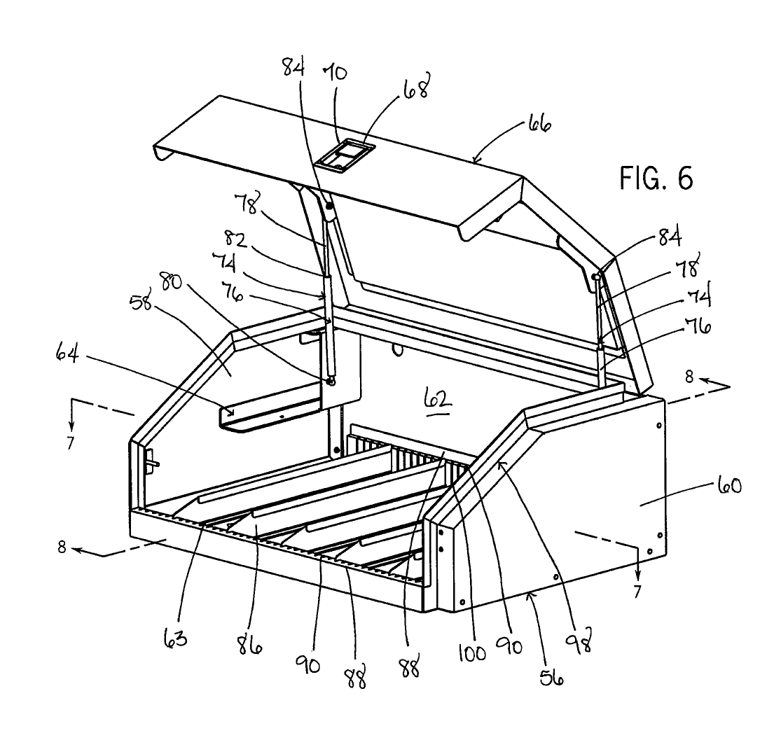

With particular reference now to FIG. 6, the interior 62 of the storage container 18 is shown in detail. When the cover 66 is in its open position as shown, the cover 66 may be supported by a number of connector elements 74 such that the cover 66 may be released once it reaches the open or raised position without further assistance from the user. The connector element 74 may be any number of connecting elements such as for example hydraulic or pneumatic cylinders or the like. As illustrated, the connector element 74 include a cylinder 76 and a rod 78 that is receivable and movable within the cylinder 76 and with respect thereto between a retracted position when the cover 66 is closed and an extended position when the cover 66 is open. In particular, as the cover 66 is rotated, the rod 78 extends or retracts to enable the cover 66 either open or close respectively. In at least one construction of the storage container 18, the connector element 74 is configured to urge the cover 66 toward the open or closed position. In particular, the connector element 74 may be configured so that when the cover 66 is moving to its open position and reaches a predetermined point between the closed and open positions, the connector element 74 is configured to bias the cover to the open position. Understandably, the connector element 74 may alternatively or additionally be configured so that when the cover is moving to its closed position and reaches a predetermined point between the open and closed position, the connector element 74 is configured to bias the cover 66 toward the closed position.

The cylinder 76 may include a first end 78 having a mounting arrangement 80 that is configured to receive a fastener such as a pin or the like for securing the first end of the cylinder 76 to one of the respective side walls 58, 60 of the base 56. Opposite the first end 78, the cylinder 76 includes a second end 82 which includes an opening for receiving the rod 78. As is generally understood in the art, the rod 78 is selectively movable within the interior defined by the cylinder 76. The rod 78 may include a piston or other such member (not shown) at a first end thereof. The rod 76 includes a second end opposite its first and which includes a mounting arrangement 84. The mounting arrangement 84 is configured to receive a fastener such as a pin that is secured to a flanged section of the cover 66 or elsewhere along a length thereof. Alternatively, the storage container 18 may be provided without any connecting arrangement, or the storage container 18 may have one or more additional connector elements 74. Understandably, other mounting arrangements for the connector elements are within the scope of the present invention. In at least one alternative construction of the connector element 74, the rod 78 may be coupled to the respective side wall 58, 60 while the cylinder is coupled to the cover 66 as may be readily appreciated.

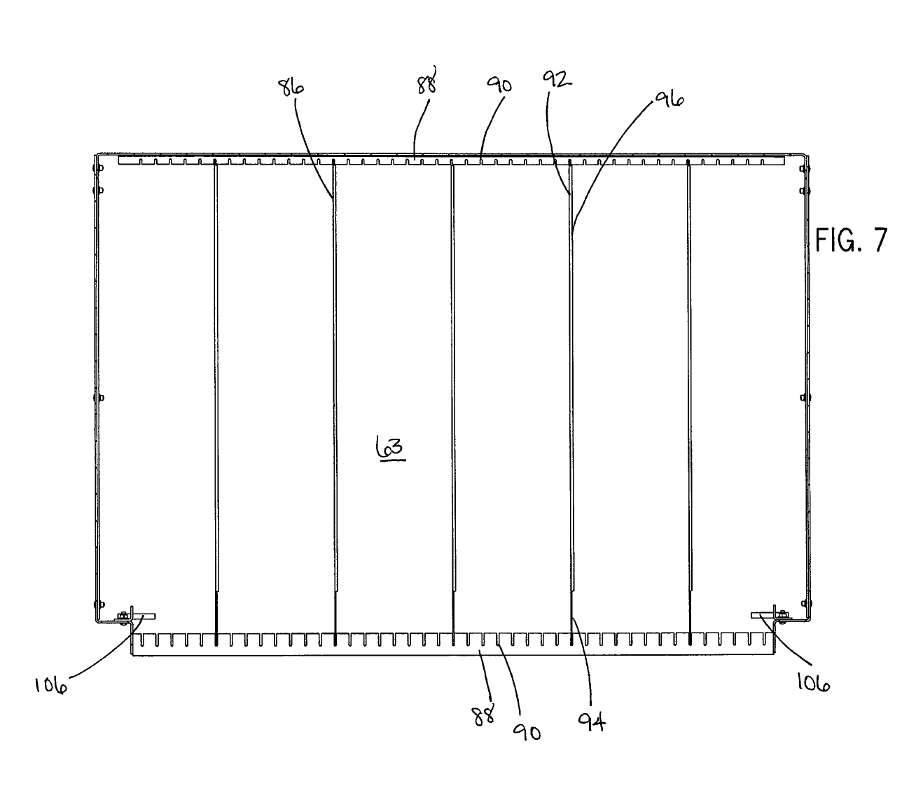

With continuing reference to FIG. 6 and additionally FIG. 7, the interior 62 of the storage container 18 may be selectively configurable. The interior 62 may include a number of laterally extending dividers 86. The dividers 86 may be constructed from relatively slender pieces of the same or similar material as storage containers 18 or any other material as may be desired. The base 56 may include a number of support elements 88 arranged at or near the bottom of the interior 62 at opposite ends thereof. The support elements 88 may include a number of spaced slots or receivers 90 extending along the length thereof. The receivers 90 may be sized and shaped for receiving the ends of the dividers 86. The dividers 86 may be arranged anywhere along the width of the base 56 and in any manner desired. Thus, the storage container 18 may be configured to include any number of individual compartments separated by the dividers 86 to accommodate any number of items to be stored within the interior 62 of the storage container 18. The dividers 86 may be selectively movable so as to define compartments having a varying number of sizes and shapes. In addition, while the interior 64 is shown such that the dividers 86 extend across the entire width of the storage container 18, it is understood that the dividers 86 may have any number of alternative shapes and configurations such that the compartments defined by the dividers 86 within the interior 62 may have any number of desired shapes and/or sizes.

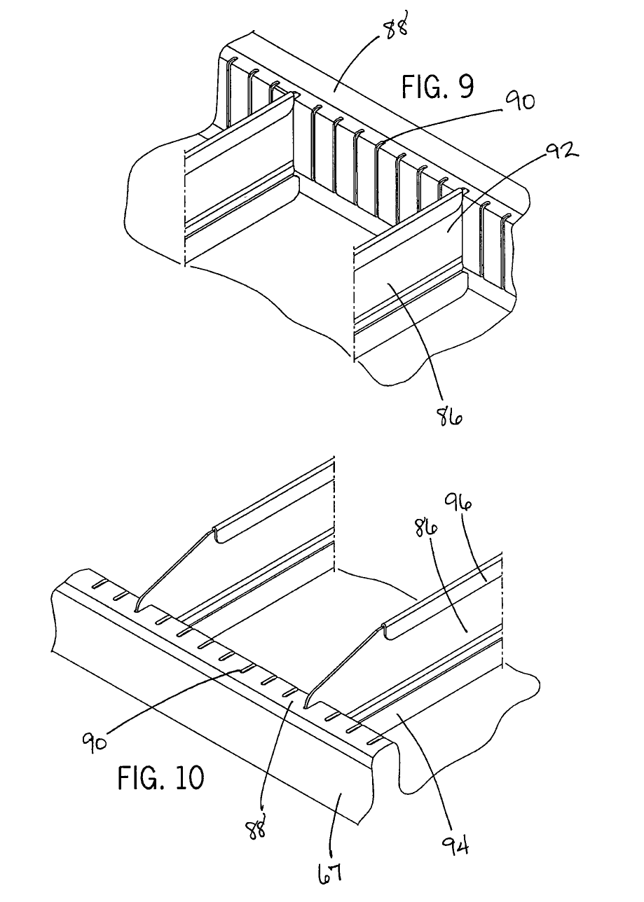

With additional reference now to FIGS. 9 and 10, detailed illustrations of the engagement of the dividers 86 with the receivers 90 of the interior 62 of the storage container 18 are provided. The dividers 86 include a first end 92 and a second end 94 opposite the first and 92. The first end 92 of the dividers 86 may be received within the receivers 90 disposed along the back wall 60 of the storage container 18. The receivers 90 may be generally elongated slots configured to securely receive the ends of the dividers 86. The receivers 90 may be provided with grooves or projections configured to releasably engage a corresponding groove or projection of the dividers 86 as may be generally understood. The dividers 86 may additionally include a grasping portion 96 disposed along at least a portion of an upper edge of the dividers 86. The grasping portion 96 may be configured to be grasped by the user of the storage system 10 for selectively lifting and removing the dividers 86 from the interior 62 of the storage container 18. Understandably, the dividers 86 may be entirely devoid of a grasping portion or may include some alternative means for being grasped. With particular reference now to FIG. 10, the second end 94 of the dividers 86 may have a generally sloped or angled shape to conform to the front edge of the storage container 18. In particular, the shape of the second end 94 may be configured to conform to the front lip 67 of the base 56 of the storage container 18. That is, because the front lip 67 of the storage container 18 is generally shorter than that of the sides 58 and 60 and the back wall 62, the second end 94 of the dividers 86 may be angled so as to conform thereto. The receivers 90 of the front lip 67 of the storage container 18 may be similarly constructed as to the receivers 90 of the back wall of the storage container 18. In the alternative, the base 56 may be entirely devoid of dividers and may be configured to a single compartment. Understandably, the base 56 in the interior 62 thereof may be alternatively constructed for the creation of one or more additional compartments as may be desired.

As may be readily appreciated, the undercut front lip 67 of the base 56 provides the storage container 18 with a significant advantage. In particular, when the cover 66 is lifted to its open position the front lip 67 of the storage container 18 is situated such that it is relatively easy for the user of the storage container 18 to access the contents thereof. That is, the undercut nature of the front lip 67 of the base 56 of the storage container 18 enables the user to access the contents and remove the contents without undue lifting or straining to move the contents out of the storage container 18 and to clear the front lip 67 thereof.

Still referring to FIG. 6, the storage container 18 may also include a sealing arrangement 98 disposed between the base 56 and the cover 66. The sealing arrangement 98 includes one or more seal elements 100 secured to an upper edge of the base 56. The seal elements 100 may be generally flexible, resilient plastic elements configured to be received over the upper edge of the base 56. The seal elements 100 may be in the form of a gasket or other sealing element and are configured to protect the contents of the interior 62 from weather damage by water, snow, ice and the like.

With additional reference now to FIGS. 7, 8, and 11, storage container 18 may additionally include one or more latch assemblies 102 for securing the cover 66 to the base 56. The latch assembly 102 is configured to provide additional security to the contents of the storage container 18 to prevent the items from being thrown therefrom during travel. As illustrated, the latch assembly 102 includes a housing 104 secured to the cover 66 and which is configured to securely engage an elongate element 106 projecting longitudinally from the respective side wall 58, 60. The latch housing includes a catch member 108 received in a slot or recess 110 of the housing 104 and configured to be movable within the housing 104. In particular, when the cover 66 is lowered to the closed position, the catch member 108 strikes the respective elongate element 106, and is moved toward an edge of the housing 104 such that the elongate element 106 is received within the recess 110 and then once the elongate element 106 clears the catch member 108, the catch member 108 is moved to its initial position by a biasing element such as a spring or the like. In this manner, the catch member 108 securely retains the elongate element 106 within the recess 110. When moving the cover 66 to the open position, the force applied by the elongate element 106 on the catch member 108 moves it toward the end of the housing 104 so that the elongate element 106 is cleared by the catch member 108 for movement of the cover 66 to its open position.

Of course, alternative latching assemblies are within the scope of the present invention, and the present invention is in no way limited by the foregoing. For example, the latch assembly 102 may alternatively be carried on the base 56 while the elongate element 106 is carried on the cover 66.

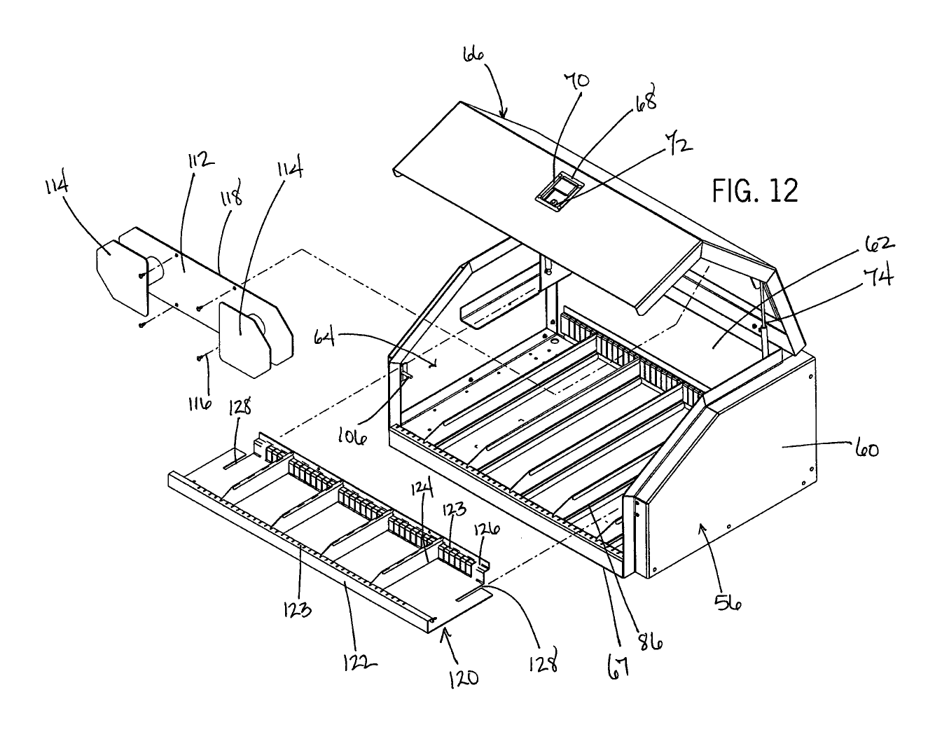

With additional reference now to FIGS. 12-17, a number of auxiliary storage accessories and components of the storage system 10 are illustrated. Referring first to FIG. 12, the cover 66 may additionally include a mounting arrangement 112 on an interior portion thereof. The mounting arrangement 112 may include one or more mounting brackets 114 secured to the interior side of the cover 66 and configured to hold one or more items. For instance, the mounting arrangement 112 may be configured to hold jumper cables, cords or any other such items that may be wrapped about the brackets 114. The mounting arrangement 112 may be secured to the cover 66 by way of a number of fasteners 116 of the kind generally known in the art. The fasteners may be received through a number of corresponding apertures 118 of the mounting arrangement 112.

Still referring to FIG. 12, the base 56 may include an auxiliary storage shelf 120. The auxiliary storage shelf 120 may be mounted to an interior of the base 56 at a vertical location above that of the compartments defined by the dividers 86. For instance, the auxiliary storage shelf 120 may be supported on a pair of brackets such as 212, which are mounted to the inner surfaces of side walls 58, 60. The auxiliary storage shelf 120 may be configured in much the same manner as the interior 64 of the storage container 18. In particular the auxiliary storage shelf 120 may include a forward edge 122 including a number of retainers 123 for receiving a forward end of a number of dividers 124. The storage shelf 120 may include an opposing rearward edge 126 for receiving the rear edge of the dividers 124 in corresponding retainers 123. As with the compartments defined by the dividers 86, the dividers 124 of the secondary storage shelf 120 may be selectively spaced relative to one another to define a number of compartments for storing a number of items. The auxiliary storage shelf 120 further includes a pair of spaced slots 128 at opposing longitudinal ends thereof. The spaced slots 128 are configured to releasably engage an upper edge of the dividers 86 of the interior 64. In this manner, the auxiliary storage shelf 120 is easily installed and removed from the interior 64 of the storage container 18 in a secure manner.

The auxiliary storage shelf 120 may have any alternative construction. For instance, the auxiliary storage shelf 120 may be entirely devoid of dividers 124 or may extend across all or only a portion of the interior 64.

Now referring to FIG. 13, a representative illustration of a rectangular tray-type storage element 130 of the storage system 10 is provided. Tray-type storage element 130 has a pair of opposing end walls 132 and a pair of opposing side walls 134 that are transverse to the end walls 132 and which together with a bottom wall 136 form a storage area for receiving items to be stored. The tray-type storage element 130 may be sized and shaped similarly to that of the storage containers 18 such that one or more tray-type storage elements 130 may be secured on the sub-frame 16. The tray-type storage element 130 enables the user of the storage system 10 to store larger items that would not otherwise fit within the storage containers 18 while still being operable with the storage system 10. Understandably, while the tray-type storage element 130 is shown as rectangular, it may be alternative constructed and may be any number of alternative shapes. In addition, while the sides of the tray-type storage element 130 are shown as having a uniform height and length, understandably, the tray-type storage element 130 may be modified to have, e.g., one or more undercut or raised side walls or the like.

Similarly, FIG. 14 illustrates an upright storage bin or box 138 for use with the storage system 10. The storage box 138 may have a rectangular cross section which has a pair of opposing end walls 140, a pair of opposing side walls 142 generally transverse to the end walls 140, and a bottom wall (not shown), which together define an interior 144 for receiving items to be stored within the storage box 138. As with the tray-type storage element 130, the storage box 138 may have a number of alternative constructions. In addition, the storage box 138 may have a number of flanges 146 disposed about a periphery of an upper edge thereof. The flanges 146 may define means for mounting to the storage system 10 or within a storage container 18. The storage box 138 may be sized and configured for cooperating with the storage system 10 in a similar fashion to the storage containers 18 and may be similarly disposed about the storage system 10 on the sub-frame 16. In the alternative, the storage box 138 may be sized and configured for positioning between the storage containers 18 supported on the sub-frame 16 to provide additional storage therebetween as may be desired. In the alternative, the storage box 138 may be provided between a cab of the vehicle and the forward edge of a storage container 18 to similarly provide additional storage. Storage box 138 is particularly well suited for storing taller items or items that do not typically require access during use, such as an air compressor or other operating piece of equipment.

Now referring to FIG. 15, another alternative storage element 148 is shown. The storage element 148 includes a pair of end walls 150, a pair of opposing side walls 152 transverse to the end walls 150 and defines a space therebetween for receiving items to be stored within the storage system 10. The storage element 148 may include a number of flange elements 154 that extend downwardly from the end walls 150 and from at least one side wall 152 and which include a distal end 156 that is orthogonal to the end walls 150 and the side walls 152. The distal end 156 may include an aperture 158 for receiving a fastener for securing the storage element 148 to, e.g., the sub-frame 16. Storage element 148 is particularly well suited for storing items such as such as fuel cans, water cans, etc.

With reference now to FIG. 16, a support member 160 is shown and includes a base 162 supporting a pair of upright members 164, which in turn support a pair of transversely oriented supports 166. The supports 166 may be configured for securely receiving any number of items and being disposed at any point on the sub-frame 16 in keeping with the spirit of the invention. The base 162 may include a number of apertures 168 for receiving fasteners for securing the base 162 to the sub-frame 16. Support member 160 is particularly well suited for storing towing-related items such as a towing dollie.

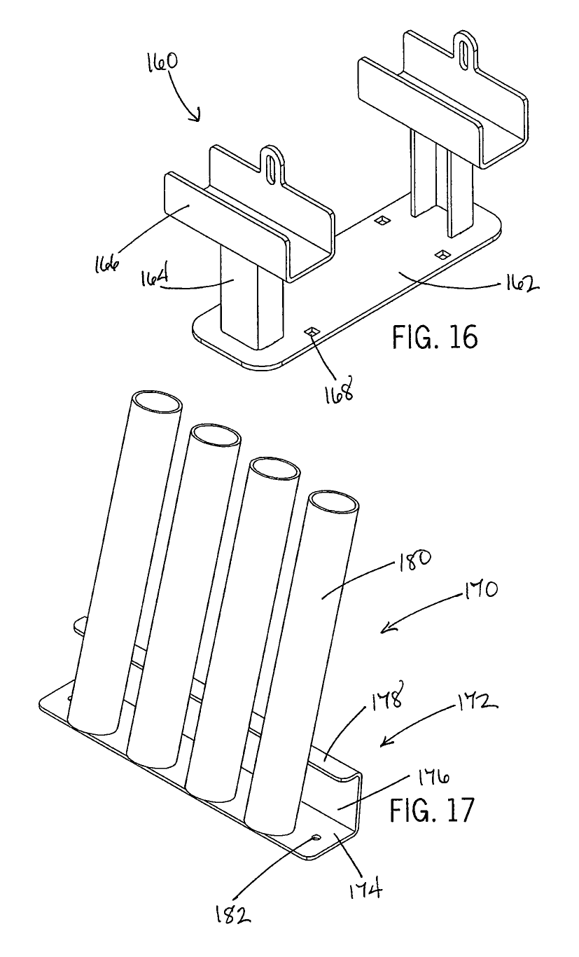

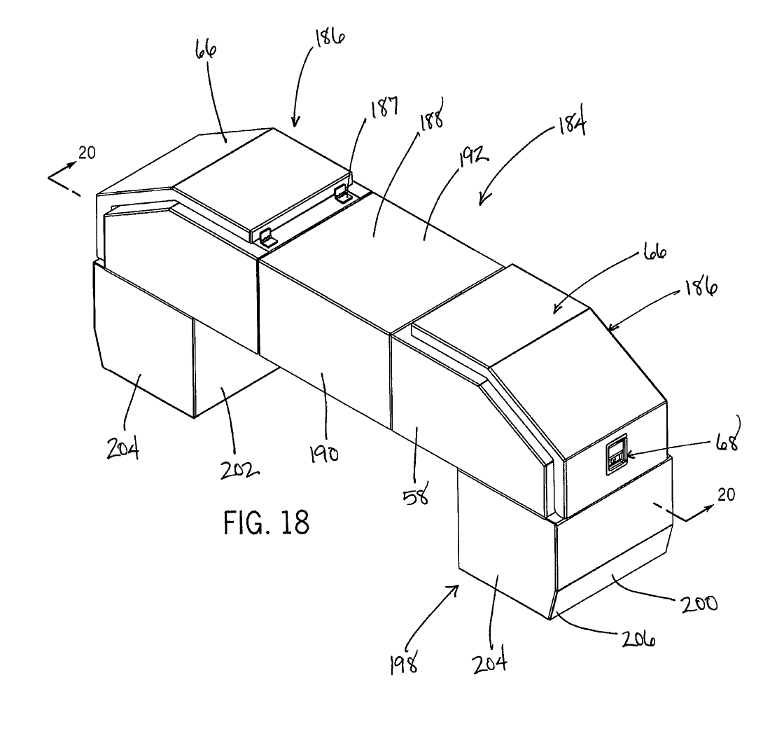

Referring now to FIG. 17, yet another storage assembly 170 is illustrated. The storage assembly 170 includes a base 172 including a generally planar bottom wall 174, a transverse side wall 176 and an upper wall 178, which defines an upper edge of the storage assembly 170. The bottom wall 174 supports a number of upright members 180, which extend upwardly therefrom and which may be configured for securely receiving any number of items. The upright members 180 may have a cylindrical cross section as shown or another such cross section such as rectangular or some other polygonal shape. The bottom wall 174 may include a number of apertures 182 for receiving fasteners for securing the storage assembly 170 to the sub-frame 16. Support member 170 is particularly well suited for storing items such as long-handled tools such as shovels, rakes, etc.

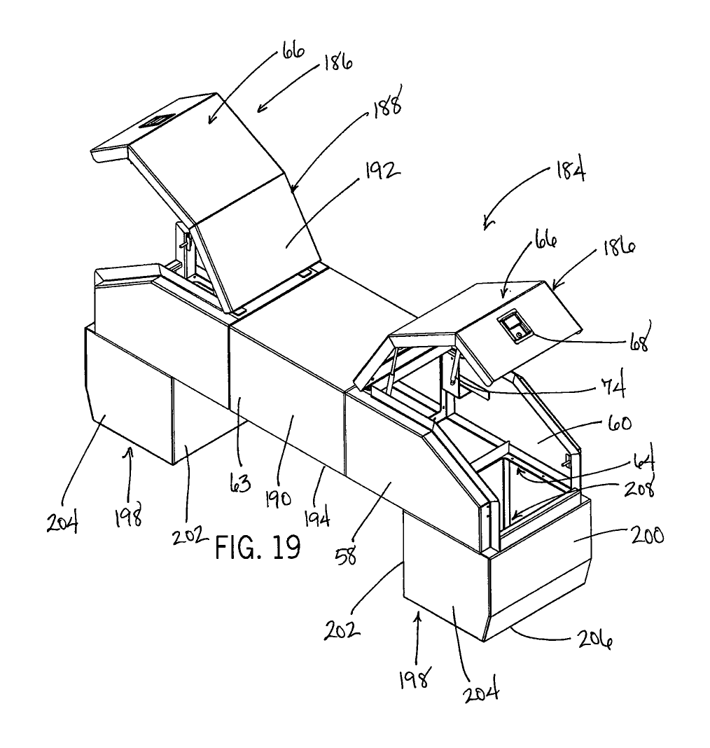

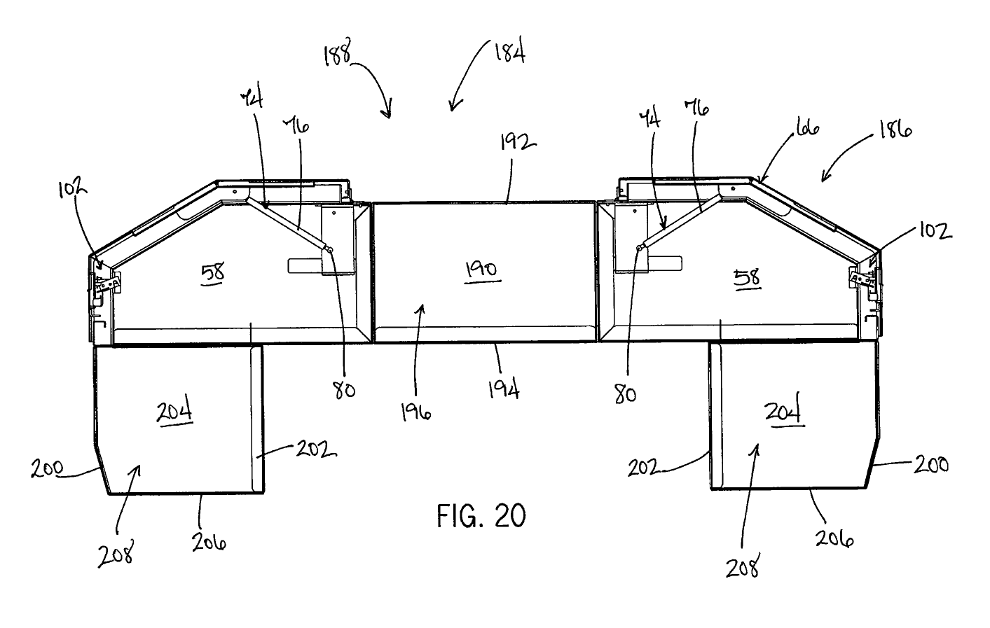

Turning now to FIGS. 18-20, another storage assembly 184 for use with the storage system 10 according to the invention is shown. The storage assembly 184 may include a pair of opposed storage containers 186 that may be similarly constructed as storage containers 18 discussed herein unless otherwise indicated. The storage containers 186 are configured for positioning on opposing ends of the sub-frame 16 and are connected to one another by an intermediate cabinet 188. The cabinet 188 may have a rectangular shape or any other similar such shape. The cabinet 188 includes a pair of opposing side walls 190, a top wall 192 transverse thereto, and a bottom wall 194 transverse to the side walls 190 and parallel with the top wall 192 and configured to define an interior 196 for receiving items to be stored therein as will be described herein.

The storage containers 186, as previously indicated, include a similar construction as the storage containers 18. Accordingly, the storage containers 186 include a base 56, a pair of side walls 58, 60, a rear wall (not shown), and a bottom wall 63 defining an interior 64 for holding items. The rear wall may be selectively removable or the storage container 186 may be entirely devoid of one altogether. In this manner, the storage containers 186 in combination with the cabinet 188 may define a tunnel that is configured to store relatively elongate items across the entire length of the storage assembly 184. Understandably, the storage assembly 184 may be configured so that only one of the storage containers 186 is absent its rear wall so that one of the storage containers 186 may serve as a standalone unit while the other of the storage containers 186 may store items in conjunction with the cabinet 188. The storage containers 186 include a handle assembly 68 and latch assembly 102 like that previously discussed for moving the cover 66 relative to the base 56 or for securing the cover 66 to the base 56 as may be desired. The cover 66 may be hingedly connected to the base 56 by hinge elements 187. The interiors 64 of the storage containers 186 of the storage assembly 184 may be similarly configurable to the storage containers 18 as previously articulated herein.

The storage assembly 184 may further include a pair of lower storage cabinets 198. The lower storage cabinets 198 may be integrally formed with the storage containers 186 or may otherwise be coupled or joined thereto. In particular, a bottom wall or portion of the bottom wall of the storage containers 186 may be selectively removable or may be entirely absent. The lower storage cabinets 198 may include a front wall 200, a rear wall 202 opposite the front wall, a pair of side walls 204 and a bottom wall 206. The lower storage cabinets 198 may be entirely devoid of an upper wall or may have a selectively removable upper wall opposite the bottom wall 206. In this manner, an interior 208 of the lower storage cabinets 198 may cooperate with its respective storage container 186 for storing items therebetween. In this way, the storage assembly 184 may securely hold a number of items that may not otherwise fit within the storage container 186 alone.

It is to be understood that the storage containers 18 and 186 may be similarly constructed in keeping with the present invention or that the storage container 18 may include elements of storage containers 186 and vice versa.

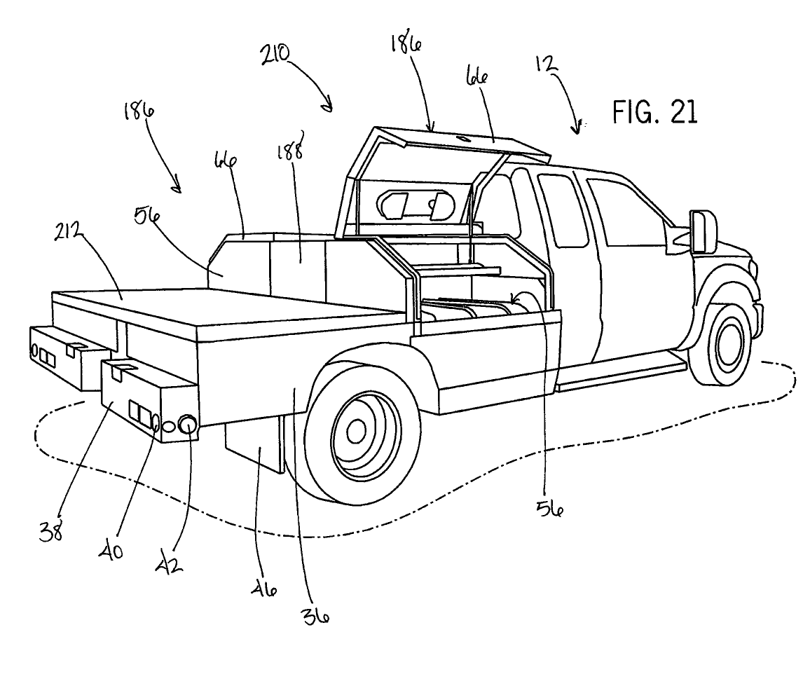

With additional reference now to FIG. 21, an alternative construction of the modular vehicular storage system 210 according to the invention is shown. As illustrated, the storage system 210 is mounted to a vehicle 12 like that of FIG. 1. It is to be understood that the storage system 210 may be substantially similar to storage system 10 and operate in much the same manner. The storage system 210 includes a pair of storage containers 186 on opposite sides of the vehicle 12 and positioned immediately adjacent the cab of the vehicle 12. The storage containers 186 may include a cabinet 188 disposed therebetween and operate in much the same manner previously discussed. Understandably, in the alternative, the storage system 10 may include a pair of storage containers 18 like those previously described and entirely devoid of the cabinet 188. In this manner, a space may be provided between the rear sides of the storage containers as may be desired for receiving any number of items or for operator ingress or egress.

A platform 212 may be positioned rearwardly of the storage containers 186. The platform 212 may be sized and shaped to correspond to the given chassis construction of the vehicle 12. The platform 212 may be configured to be secured to the chassis of the vehicle by way of the sub-frame 16 in much the same manner as the storage containers 186. Understandably, the platform 212 may be configured to be selectively expandable and retractable in a fashion similar to the sub-frame 16 so that a single platform 212 may accommodate a number of different chassis and vehicle sizes and configurations. The platform 212 is generally configured to support items on a surface thereof as may be desired. The platform 212 may alternatively serve as a location for to enable the operator to access the contents of the storage containers 186 or for standing or otherwise accessing for any number of operations, which may be desirable.

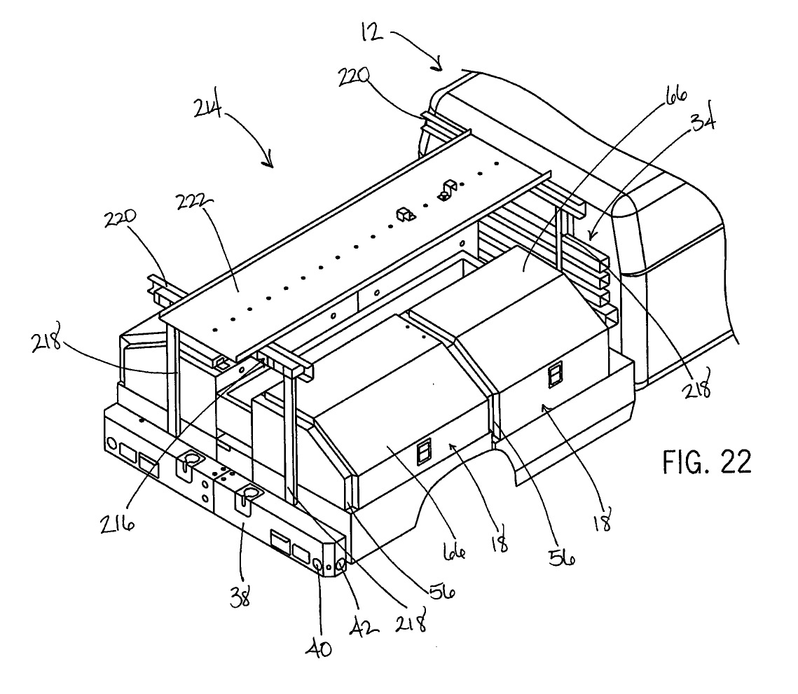

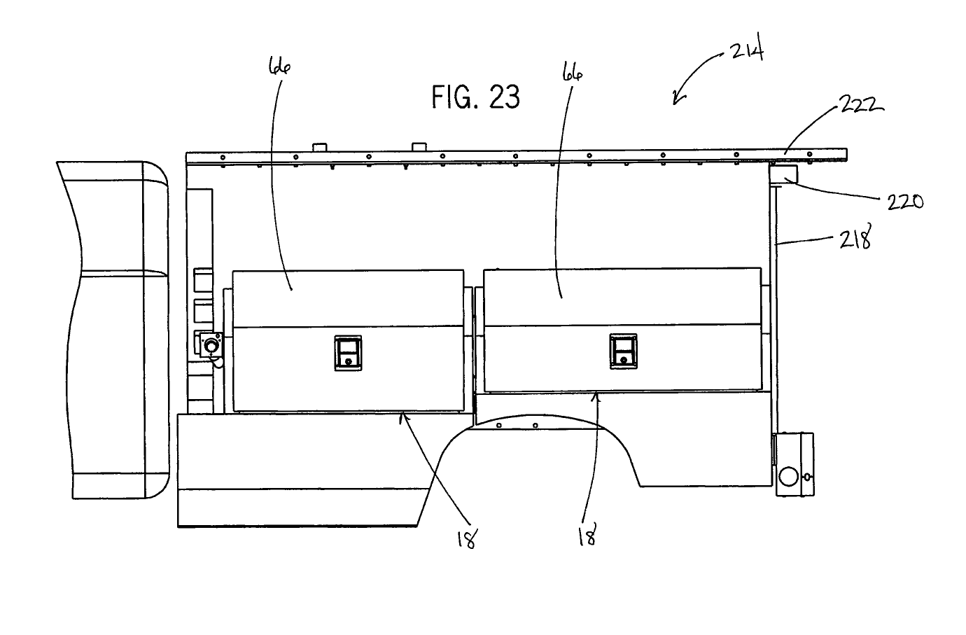

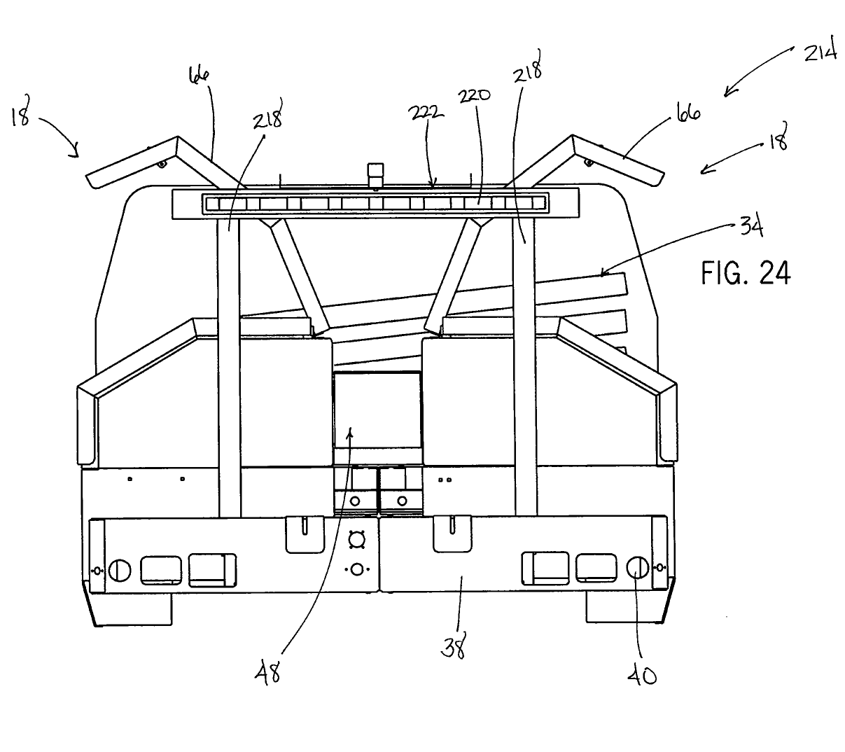

With additional reference now to FIGS. 22-24, an alternative construction of the modular storage system 214 according to the invention is shown. As illustrated, the storage system 214 is mounted to a vehicle 12 as previously described. The storage system 214 includes a number of storage containers 18 constructed in the manner previously described herein. Understandably, the storage containers 18 may be modified or have an alternative construction such as those described herein. The storage system 214 includes an overhead support arrangement 216 including a pair of spaced upright supports 218 at each end of the rear of the vehicle. In other words, the pairs of upright supports 218 are provided adjacent or abutting with the cab of the vehicle 12 and at the rear fender or tailgate area of the vehicle, respectively. The upright supports 218 each support a lateral support member 220 that is disposed orthogonally thereto and which may extend past the ends of the support members 218 or which may be flush therewith. The lateral support member 220 may be configured to support any number of auxiliary structures including a ladder, scaffolding, or other auxiliary element 222. In particular, the auxiliary element 222 may be generally received across the length of the rear of the vehicle defining the modular storage system 214 of the present construction such that it is entirely supported at its ends by the lateral support members 220. The lateral support members 220 may have means for engaging the auxiliary element 222. For instance, the support members 220 may be configured to receive a fastener that is inserted through a portion of the auxiliary element 222 for securing the auxiliary element 222 thereto. Alternatively, the lateral support members 220 may be otherwise configured to support the auxiliary element 222 by, for example, a number of depressions, recesses, projections or the like configured to engage at least a portion of the auxiliary element 222.

As may be readily appreciated by reference to, in particular, FIGS. 22 and 24, the overhead support arrangement 216 may be configured so that the auxiliary element is positioned out of the way of the covers 66 of the storage containers 18 when the covers 66 are moved to their open positions. In this manner, the operator may still access the interiors of the storage containers 18, while the auxiliary element 222 is mounted on the storage system 214. For instance, as shown in FIG. 22, the auxiliary element 222 may be positioned over the space 48 between the storage containers 18. Further, the overhead support arrangement 216 may be configured to be elevated above the height of a rear window of the vehicle 12 so that a driver's view is not compromised while traveling with auxiliary element 222 mounted to the storage system 214.

As may be readily appreciated, the modular nature of the storage system 10 of the invention is such that the entirety of the storage system 10 may be shipped via common carrier rather than by special shipping. That is, each of the individual components of the storage system 10 are sized and configured for common carrier shipping, such as on a pallet, which greatly reduces the shipping costs as compared to other vehicle storage systems. Yet another advantage of the storage system 10 is that it is sized and configured to not interfere with the driver's line of sight. In particular, because of its wide and deep storage capacity, the storage system 10 need not extend into the driver's line of sight to accommodate the items to be stored therein. Further, it is understood that the space between the storage containers 18 may be utilized for storing elongate items, which further eliminates any obstructions. While the storage containers 18 and 186 of the present invention have been described in detail, it is understood that they may be alternatively constructed in any number of ways keeping in the spirit of the invention. As may be appreciated from the foregoing description, the storage system 10 of the invention may be configured to accommodate a fifth wheel-type hitch to allow the vehicle to be used with so-called gooseneck trailers while still providing a large storage area.

The invention has been described in terms of preferred representative embodiment, and it is recognized that equivalents, alternatives, and modifications, aside from those expressly stated, are possible and within the scope of the appending claims.

What is claimed is:

1. A vehicular storage system comprising:
a configurable sub-frame mountable to a vehicle; and
at least one storage container removably mountable to the sub-frame.

2. The vehicular storage system of claim 1, wherein the sub-frame is configurable in an expanded configuration, a contracted configuration, and at least one intermediate configuration between the expanded configuration and the retracted configuration.

3. The vehicular storage system of claim 1, wherein the sub-frame comprises a number of rails and a number of rail engaging members, wherein the rail engaging members are configured to move relative to the rails to move the sub frame between the expanded and retracted configuration.

4. The vehicular storage system of claim 1, wherein the storage container defines an interior configured for storing items.

5. The vehicular storage system of claim 1, wherein the storage container includes a base and a cover movably coupled to the base between an open and a closed position.

6. The vehicular storage system of claim 1, wherein the storage container comprises a base having a pair of opposed side walls, a rear wall, a bottom wall, and a forward edge, wherein the forward edge has a height lower than the side walls, rear wall, and bottom wall.

7. The vehicular storage system of claim 1, wherein the storage container comprises a cover and at least one connector element configured to urge the cover toward at least one of a closed position and an open position.

8. The vehicular storage system of claim 1, wherein the storage container defines an interior and further comprising at least one selectively movable divider configured to define a plurality of compartments within the interior.

9. The vehicular storage system of claim 1, wherein the storage container comprises a handle assembly carried by a cover thereof and including a locking element configured to prevent movement of the cover from a closed position.

10. The vehicular storage system of claim 1, wherein the storage container comprises a latch assembly coupled to a first portion thereof and configured to engage a second portion of the storage container for selectively coupling the first portion to the second portion.

11. A storage container for use with a vehicular storage system, the storage container comprising:
a base having a first side wall opposite a second side wall, a rear wall, a bottom wall, and a forward edge defining an interior for storing items;
a cover movably coupled to the base between an open and a closed position at the rear wall and selectively coupleable to the forward edge to close the storage container.

12. The storage container of claim 11, further comprising at least one connector element coupled between the base and the cover and configured to urge the cover to at least one of the open and closed positions.

13. The storage container of claim 11, wherein the interior is selectively configurable into a plurality of compartments.

14. The storage container of claim 11, wherein the cover carries a handle assembly that is selectively graspable by a user for moving the cover between the open and closed positions.

15. The storage container of claim 11, further comprising a latch assembly including at least one latch housing carried by one of the base and the cover and at least one elongate element selectively engageable by the latch housing and carried by the other of the base and the cover.

16. The storage container of claim 15, wherein the latch housing includes a biased catch member configured to selectively retain the elongate element and movable within the latch housing.

17. A method of providing a storage system on a vehicle, the method comprising the steps of:
assembling a sub-frame, wherein the sub-frame is selectively moveable between an expanded and retracted position;
securing the sub-frame to the vehicle; and
coupling at least one storage element to the sub-frame for storing items on the vehicle.

18. The method of claim 17, wherein the storage element comprises a storage container including a base and cover movably coupled to the base between an open and closed position.

19. The method of claim 17, further comprising the step of dividing an interior of the at least one storage element into a plurality of compartments.

20. The method of claim 17, wherein the sub-frame comprises at least one rail and one rail engagement member, wherein the rail engagement member is selectively movable along the rail for moving the sub-frame between the expanded and the retracted positions.

21. The method of claim 17, wherein the step of coupling at least one storage element to the sub-frame comprises selecting the storage element from one of a plurality of differently configured storage elements.
